(19) United States
(12) Patent Application Publication
(10) Pub. No.: US 2023/0030678 A1
(43) Pub. Date: Feb. 2, 2023

(54) PET TOY WITHIN A TOY

(71) Applicants: Danielle Salyer, Denver, CO (US); Lisa Marie Matwijiw Larson, Vista, CA (US)

(72) Inventors: Danielle Salyer, Denver, CO (US); Lisa Marie Matwijiw Larson, Vista, CA (US)

(21) Appl. No.: 17/391,907

(22) Filed: Aug. 2, 2021

(51) Int. Cl. A01K 15/02

(52) U.S. Cl. CPC A01K 15/025

(57) ABSTRACT

The invention comprises a pet toy where the toy can be made to look like an animal or a fictitious character such as a unicorn. The outer shell is molded TPE and transparent so the pet can see a second inner toy inside which has a squeaker set-in to it and will squeak when the shells are compressed by a pet. The pet can see that there is an inner toy, but it does not dislodge from the outer shell.

### FIELD

The invention relates to a novel pet toy that is a molded, translucent animal character toy and shows a second squeaking toy within the body of the character. The pet can chew both pieces without the second internal toy falling out of the outer shell, yet an aperture in the outer body allows for enhanced sound disbursement.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel molded character that contains a second toy within the molded outer shell. Both pieces can contain squeakers or noisemaking devices. An aperture in the body of the outer character aids in acoustics but is not large enough to allow the internal toy to be dislodged.

There are many squeaker toys for pets on the market. The aim is trying to produce something new and novel. The inventive toy accomplishes this in several ways. The body is translucent molded poly material and allows a pet to see that there is a second toy inside the outer shell. The outer shell can be any character or animal.

### SUMMARY, OBJECTS AND ADVANTAGES

Animals can see through the outer shell of the inventive toy and become aware of a second squeaking toy inside. The internal toy can make noises and move around within the outer shell but cannot be dislodged. This aids in retaining interest by the pet as it seeks to “solve” what it perceives as a puzzle.

The inventive toy has a two-piece molded outer shell made from TPE, which is translucent so the pet can see the inner toy. The internal toy contains a squeaker or squeakers which responds when the pet compresses the entire toy.

The internal squeaking toy is also a 2-piece molded TPE shape which will relate in some way to the outer character. A reed squeaker resides inside of the bottom of the inner toy. The bottom layer is heat molded onto the inner toy with a squeaker set-in to the bottom that will not dislodge during play. An aperture at both the top and bottom of the inner toy provides air intake and release for emitting the squeaking sounds.

A 33.20 mm round aperture is located in the center or “belly” of the outer shell so that the pet can see there is a second toy within and the aperture also allows for sound disbursement when the squeaker is activated, and also can make noise by moving around within the outer shell but will not be dislodged during play. It is plain that the outer shell can be an animal or a fictional character such as a unicorn. Multiple embodiments are possible.

### BRIEF DESCRIPTION OF THE DRAWINGS

The invention is described in further detail by reference to sixteen (16) drawings sufficient in detail to describe the invention in which:

FIG. 1 is a front perspective of the toy illustrating the unicorn character;

FIG. 2 is a left perspective of the unicorn;

FIG. 3 is a perspective showing the hollow cavity of the outer shell character;

FIG. 4(a-d) are all sides of the internal toy, here, frosting;

FIG. 5 is a see-through perspective of the frosting with reed squeaker inside

FIG. 6 is a simple bottom view of the unicorn;

FIG. 7 is front see-through view of the frosting inside the unicorn;

FIG. 8 is a left side see through perspective showing the frosting inside the unicorn;

FIGS. 9 and 10 are examples of the monkey character showing the same design as the unicorn;

FIG. 11 is a see-through view of the monkey’s outer shell hollow body;

FIG. 12(a-e) is the internal banana toy with squeaker as in the monkey character;

FIG. 13the internal banana toy with reed squeaker attached to the bottom of the toy;

FIG. 14 is a rear perspective of the monkey;

FIG. 15 is a see-through perspective showing the banana and squeaker inside the monkey character; and

FIG. 16 is a side see through perspective of the monkey showing the banana inside the outer shell.

### DETAILED DESCRIPTION, INCLUDING BEST MODES OF CARRYING OUT THE INVENTION

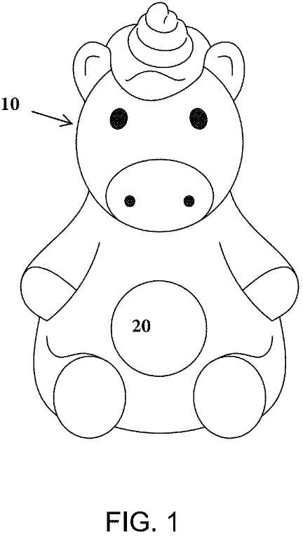

FIG. 1 shows the unicorn character body 10 and the 33.2 mm aperture in the center or “belly” of the unicorn 20. The outer shell is hollow so as to receive a second internal toy.

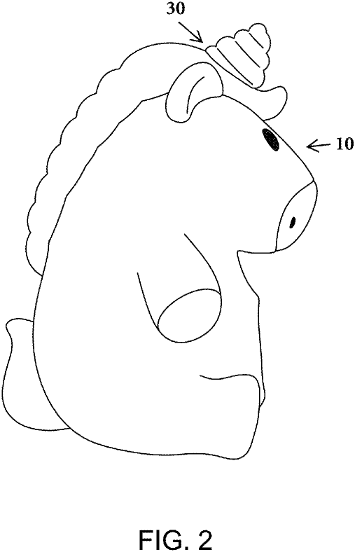

FIG. 2 is a side perspective of the unicorn character 10 and the horn features 30 that indicate what type of character the toy is.

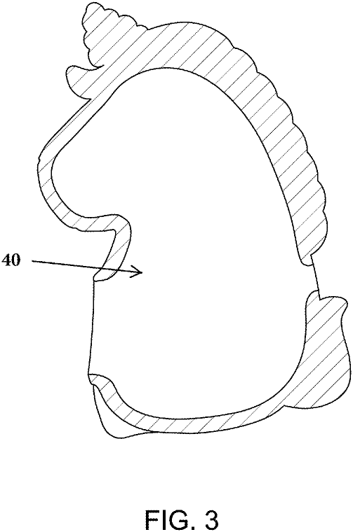

FIG. 3 illustrates the hollow body of the outer toy shell 30.

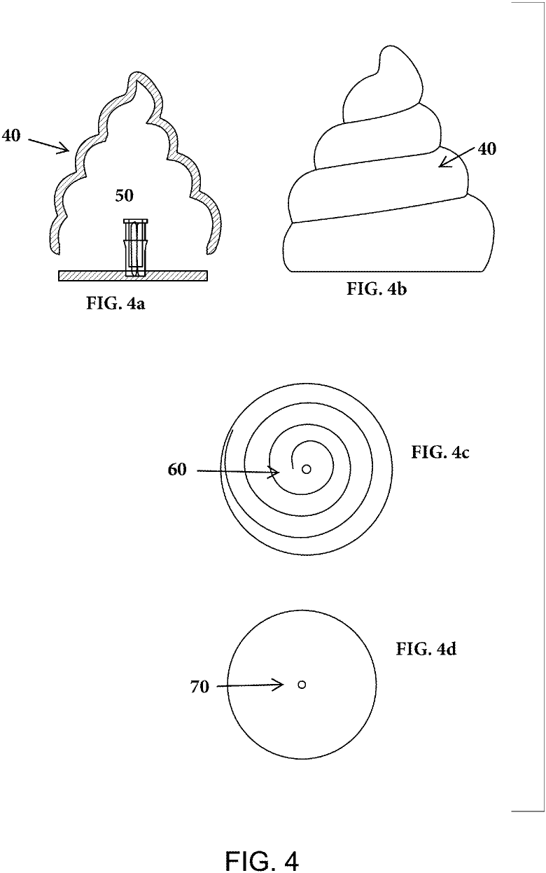

FIG. 4a is the frosting shaped inner toy 40 that goes inside the unicorn character’s hollow body in phantom with the squeaker 50 as set-in to the bottom of the frosting. 4b is the frosting piece 40 as it appears to the pet and is opaque. 4c is the top section of the frosting showing the small aperture 60 which allows air to activate with the squeaker. 4d is the bottom of the frosting showing the small aperture 70 which allows airflow for the squeaker within the frosting piece.

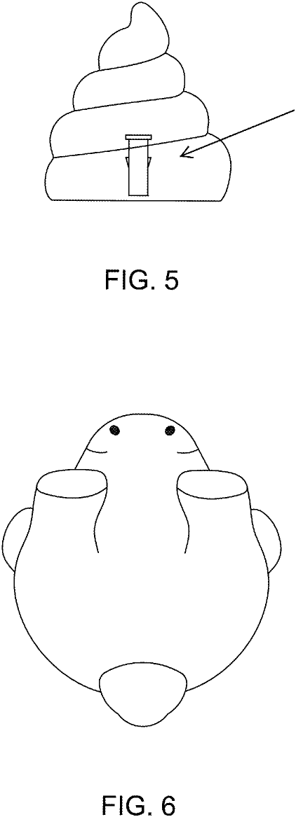

FIG. 5 illustrates the squeaker 50 in phantom to show it as imposition set-in to the inside of the frosting piece 40 of the inner toy.

FIG. 6 is the bottom of unicorn character.

FIG. 7 is the unicorn outer shell 10 with the aperture 20 and the frosting piece 40 as contained inside the outer shell.

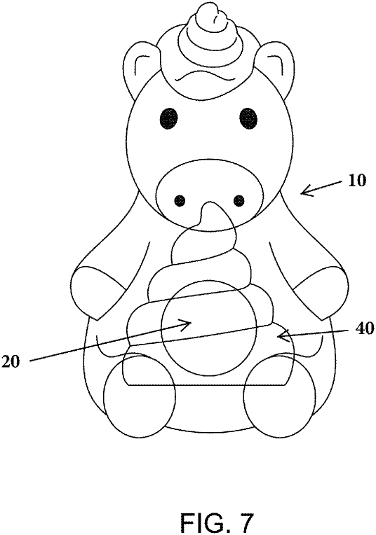

FIG. 8 is a side perspective of the unicorn 10 and the frosting piece 40 as resides in the transparent outer shell.

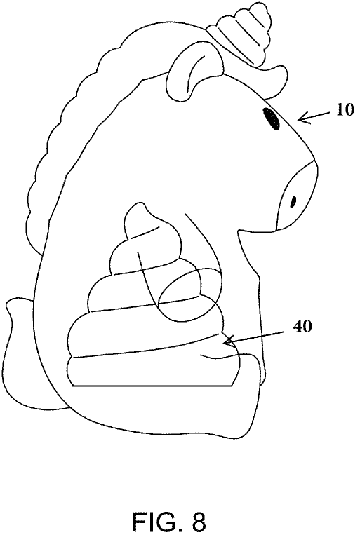

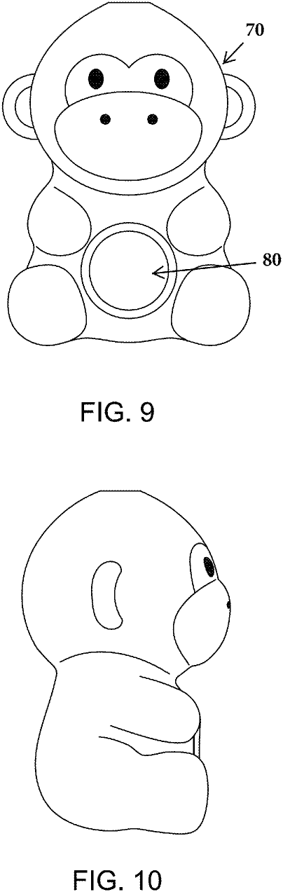

FIGS. 9 and 10 show the monkey embodiment and the similar design. The hollow body of the monkey 70 contains a similar center aperture 80 and functions the same as the unicorn character.

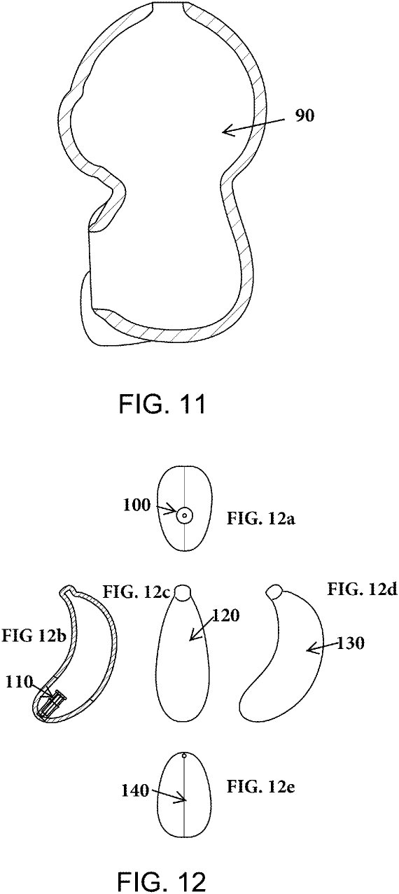

FIG. 11 shows the hollow body 90 of the monkey character.

FIG. 12a shows the top of the banana inner squeaking toy 100 as resides in the monkey character and the small aperture to allow the squeaker to intake air. FIG. 12b shows the banana and its set-in squeaker 110. This inner toy is opaque whereas the outer shell is translucent. FIG. 12c is a front view of the banana 120. FIG. 4d is a side view of the banana 130 and FIG. 12e is a top-down view of the banana 140.

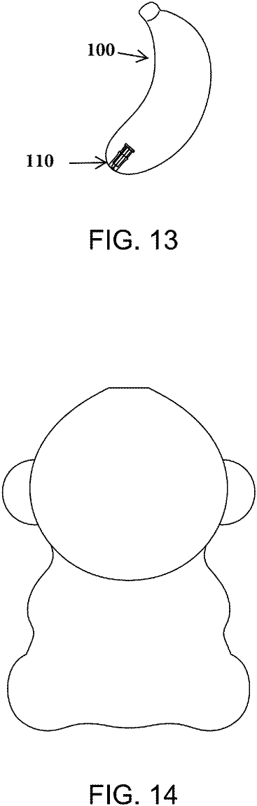

FIG. 13 is a see though view of the banana 100 and illustrates where the squeaker 110 is set-in to the banana squeaking toy, which is opaque, but shown see through as an example.

FIG. 14 is a simple rear view of the monkey character.

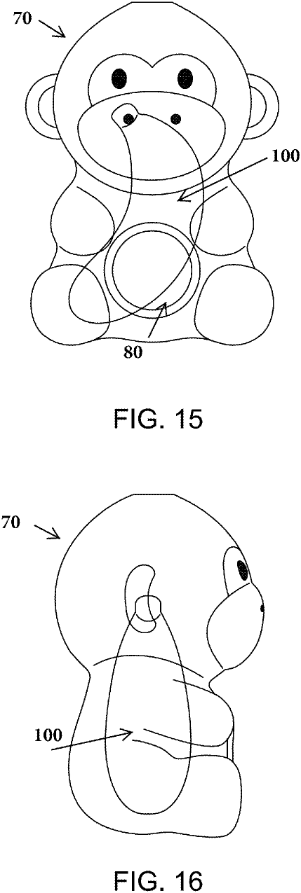

FIG. 15 is a see-through perspective of the hollow monkey outer shell 70 with the banana 100 as would be viewed through the transparent outer shell.

FIG. 16 is a side perspective of the monkey 70 and the banana 100 inside the transparent outer shell of the monkey. The pets can see the inner toy within all of the characters.

1. A two-piece molded pet toy comprising;
b) a transparent TPE outer shell wherein the shell is hollow and can be an animal shape or a fictitious character shape such as a unicorn
c) a 33.2 mm aperture cut out of the center of the outer shell
d) an opaque two-piece molded TPE inner toy with a squeaker set-in to the bottom of the inner toy which resides inside the outer shell
e) a small aperture in the top of the inner toy which allows airflow to the squeaker
f) a small aperture in the bottom of the inner toy which allows air flow to the squeaker
.

2. A two-piece molded pet toy as in claim 1 wherein the outer shell is transparent to allow a pet to see that an inner toy is contained therein.

3. A two-piece molded pet toy as in claim 1 wherein 33.2 mm round aperture is cut out of the center or belly of the outer shell which aids in allowing a view of the inner toy and to enhance sound as it is omitted from the squeakers set-in to the internal toy.

4. A two-piece molded pet toy as in claim 1 wherein the inner toy is opaque and contains a squeaker set-in to the bottom of the inner toy wherein the toy will emit sound when both shells are compressed by a pet and wherein the inner toy is not attached to the outer shell, yet cannot be dislodged through the center aperture of the outer shell.

5. A two-piece molded pet toy as in claim 1 wherein a small aperture is located on the top and bottom of the inner toy to allow airflow in and out of the squeaker when both shells are compressed by a pet and activates the squeaker with airflow.
